(19) United States
(12) Patent Application Publication
(10) Pub. No.: US 2024/0092268 A1
(43) Pub. Date: Mar. 21, 2024

(54) VEHICLE DISPLAY CONTROL DEVICE, VEHICLE DISPLAY CONTROL METHOD, AND STORAGE MEDIUM

(71) Applicant: TOYOTA JIDOSHA KABUSHIKI KAISHA, Toyota-shi (JP)

(72) Inventor: Shinya KODAMA, Nagoya-shi (JP)

(73) Assignee: TOYOTA JIDOSHA KABUSHIKI KAISHA, Toyota-shi (JP)

(21) Appl. No.: 18/223,831

(22) Filed: Jul. 19, 2023

(30) Foreign Application Priority Data
Sep. 20, 2022 (JP) 2022-149616

(51) Int. Cl. B60R 1/28

(52) U.S. Cl. CPC B60R 1/28; B60R 2300/101; B60R 2300/302; B60R 2300/70

(57) ABSTRACT

The display control ECU causes the display to display a view in a direction selected through the input unit among a plurality of views having mutually different directions obtained from the captured images acquired from the imaging unit that captures an image of the periphery of the vehicle. In addition, the display control ECU is configured such that the traveling state detecting unit that detects the traveling state and the traveling direction of the vehicle detects that the traveling of the vehicle is started, and when the view displayed on the display differs from the traveling direction of the vehicle, the view displayed on the display is switched to the view in the traveling direction of the vehicle.

### CROSS-REFERENCE TO RELATED APPLICATION

This application claims priority to Japanese Patent Application No. 2022-149616 filed on Sep. 20, 2022 incorporated herein by reference in its entirety.

### BACKGROUND

### 1. Technical Field

The present disclosure relates to a vehicle display control device, a vehicle display control method, and a storage medium.

### 2. Description of Related Art

Japanese Unexamined Patent Application Publication No. 2020-044888 (JP 2020-044888 A) describes a technique in which imaging means causes a display unit to display an acquired peripheral image, and changes the display range of the peripheral image based on the vehicle speed V of the host vehicle, which is detected by a vehicle speed sensor.

### SUMMARY

JP 2020-044888 A does not describe the relationship between the peripheral image displayed on the display unit and the traveling state or the traveling direction of the host vehicle. Therefore, in the technique described in JP 2020-044888 A, when a peripheral image in a direction different from the traveling direction of the vehicle is displayed on the display unit at the time of departure of the vehicle, the user cannot confirm the situation in the traveling direction from the peripheral image displayed on the display unit.

The present disclosure has been made in consideration of the above-described facts, and an object thereof is to provide a vehicle display control device, a vehicle display control method, and a storage medium that can suppress a user from erroneously recognizing a situation around a vehicle displayed as a view when the vehicle starts, as a situation in a traveling direction of the vehicle.

A vehicle display control device according to a first aspect includes a control unit that: causes a display unit to display a view in a direction selected via an input unit among a plurality of views having different directions obtained from a captured image acquired from an imaging unit that captures an image of a periphery of a vehicle; and switches the view displayed on the display unit to a view in a traveling direction of the vehicle, when a traveling state detection unit that detects a traveling state and a traveling direction of the vehicle detects that traveling of the vehicle is started and when the view displayed on the display unit is different from the view in the traveling direction of the vehicle.

In the first aspect, the traveling state detection unit that detects the traveling state and the traveling direction of the vehicle detects that the traveling of the vehicle has started. Further, when the view displayed on the display unit is different from the traveling direction of the vehicle, the control unit switches the view displayed on the display unit to the view in the traveling direction of the vehicle. Accordingly, it is possible to suppress the user from erroneously recognizing the situation around the vehicle displayed as a view at the time of starting the vehicle as the situation in the traveling direction of the vehicle. Thus, the user can recognize the state in the traveling direction of the vehicle when the vehicle starts from the view displayed on the display unit.

According to a second aspect, in the first aspect, when the control unit switches the view displayed on the display unit to the view in the traveling direction of the vehicle, the control unit causes a notification unit to make a notification.

According to the second aspect, it is possible to cause the user to recognize that the view displayed on the display unit has been switched.

According to a third aspect, in the first aspect or the second aspect, when a view in a direction other than the traveling direction of the vehicle is selected via the input unit after the traveling of the vehicle is started, the control unit switches the view displayed on the display unit to the view in the direction other than the traveling direction.

According to the third aspect, after the traveling of the vehicle is started, that is, after the view in the traveling direction of the vehicle is confirmed by the user, the user can switch the view displayed on the display unit to the view selected via the input unit.

A vehicle display control method according to a fourth aspect includes causing a computer to execute processes including: causing a display unit to display a view in a direction selected via an input unit among a plurality of views having different directions obtained from a captured image acquired from an imaging unit that captures an image of a periphery of a vehicle; and switching the view displayed on the display unit to a view in a traveling direction of the vehicle, when a traveling state detection unit that detects a traveling state and a traveling direction of the vehicle detects that traveling of the vehicle is started and when the view displayed on the display unit is different from the view in the traveling direction of the vehicle.

According to the fourth aspect, similarly to the first aspect, it is possible to suppress the user from erroneously recognizing the situation around the vehicle displayed as a view at the time of starting the vehicle as the situation in the traveling direction of the vehicle. The user can recognize the state in the traveling direction of the vehicle when the vehicle starts from the view displayed on the display unit.

A storage medium according to the fifth aspect stores a vehicle display control program causing a computer to execute processes including: causing a display unit to display a view in a direction selected via an input unit among a plurality of views having different directions obtained from a captured image acquired from an imaging unit that captures an image of a periphery of a vehicle; and switching the view displayed on the display unit to a view in a traveling direction of the vehicle, when a traveling state detection unit that detects a traveling state and a traveling direction of the vehicle detects that traveling of the vehicle is started and when the view displayed on the display unit is different from the view in the traveling direction of the vehicle.

According to the fifth aspect, similarly to the first aspect, it is possible to suppress the user from erroneously recognizing the situation around the vehicle displayed as a view at the time of starting the vehicle as the situation in the traveling direction of the vehicle. The user can recognize the state in the traveling direction of the vehicle when the vehicle starts from the view displayed on the display unit.

The present disclosure has an effect of suppressing a situation around the vehicle displayed as a view when the vehicle starts from being erroneously recognized as a situation in the traveling direction of the vehicle by the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a vehicle display device according to an embodiment;

FIG. 2 is a functional diagram of a display-control ECU;

FIG. 3 is a flowchart illustrating a display control process;

FIG. 4A is an image diagram illustrating an example of a view displayed on a display; and

FIG. 4B is an image figure showing an example of the view displayed on a display.

### DETAILED DESCRIPTION OF EMBODIMENTS

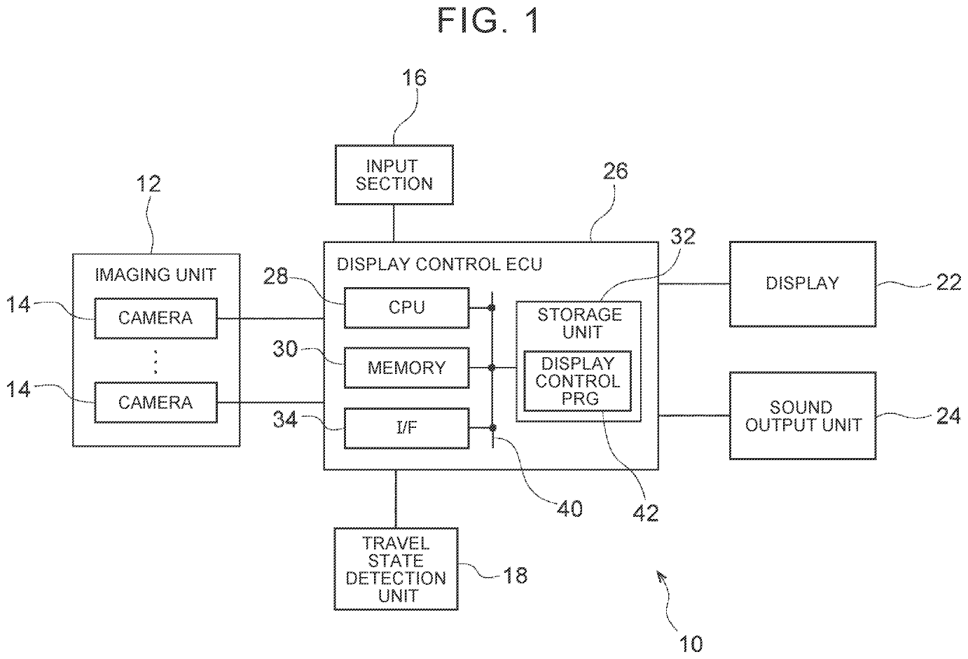

Hereinafter, an example of an embodiment of the present disclosure will be described in detail with reference to the drawings. As illustrated in FIG. 1, the vehicular display device 10 according to the present embodiment includes an imaging unit 12, an input unit 16, a traveling state detection unit 18, a display 22, an audio output unit 24, and a display control ECU 26.

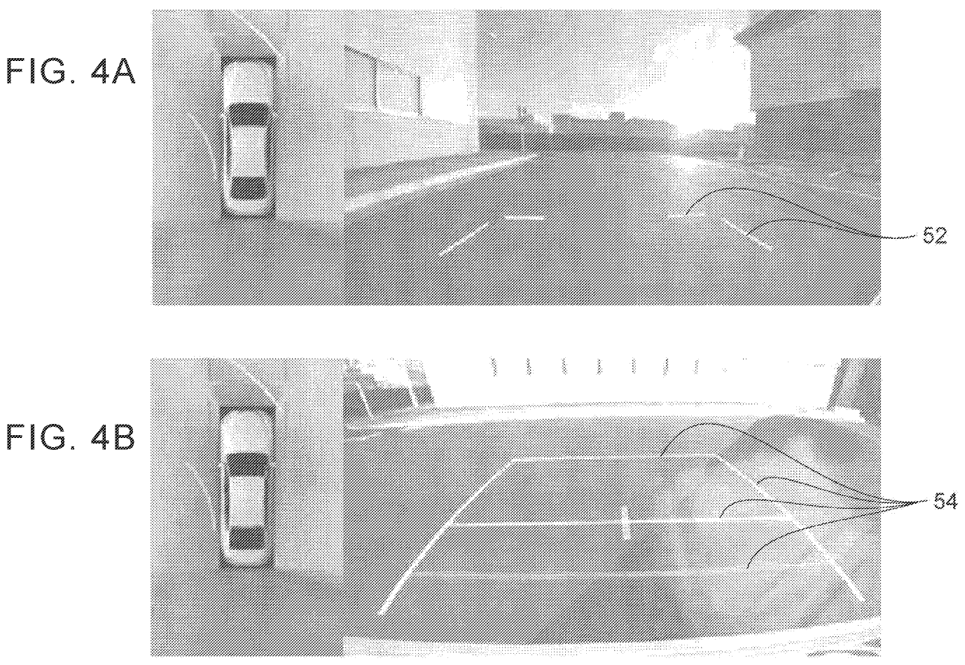

The imaging unit 12 is a functional block that captures an image of the surroundings of the vehicle. The imaging unit 12 includes a plurality of cameras 14 each mounted on the vehicle and having a mounting position and an imaging range set so as to capture images of different ranges from different positions. In the present embodiment, the imaging unit 12 includes a camera 14 that captures an image of the front side of the vehicle and a camera 14 that captures an image of the rear side of the vehicle. The imaging unit 12 can generate a view on the front side of the vehicle (for example, refer to FIG. 4A) and a view on the rear side of the vehicle (for example, refer to FIG. 4B) from the images captured by the imaging unit 12. The number of cameras 14 in the imaging unit 12 may be three or more.

The input unit 16 is a functional block for a user (for example, an occupant of a vehicle) to input information. The input unit 16 includes, for example, a four-way switch, a keyboard, or the like. The information input by the user via the input unit 16 includes information for specifying a direction of a view (a vehicle front side or a vehicle rear side) when an image (a view) of the vehicle and its surroundings is displayed on the display 22.

The traveling state detection unit 18 is a functional block that detects a traveling state and a traveling direction of the vehicle. The traveling state detection unit 18 includes, for example, a vehicle speed sensor and a shift position sensor. The vehicle speed sensor detects a vehicle speed of the vehicle. The shift position sensor is capable of detecting whether the vehicle moves forward or backward. Note that the traveling state detection unit 18 may further include a steering angle sensor that detects a steering angle of the vehicle.

The display 22 includes a center display, a meter display, or the like. The center display is disposed at a center portion in the vehicle width direction of the vehicle cabin. The meter display is disposed in front of a driver's seat of the vehicle in a vehicle cabin. On the display 22, images generated by the display control ECU 26 (for example, images such as a view on the vehicle front side or the vehicle rear side) are displayed. Note that the display 22 is an example of a display unit in the present disclosure.

The audio output unit 24 includes a buzzer for outputting a buzzer sound, a speaker capable of outputting an arbitrary sound, and the like. The audio output unit 24 is controlled by a display control ECU 26 so that a predetermined audio is output when the view displayed on the display 22 is switched. The audio output unit 24 and the display 22 are examples of the notification unit in the present disclosure.

The display control ECU 26 includes a Central Processing Unit (CPU) 28, a memory 30 such as Read Only Memory (ROM), Random Access Memory (RAM), and a non-volatile storage unit 32 such as Hard Disk Drive (HDD), Solid State Drive (SSD). The display control ECU 26 includes an InterFace (I/F) unit 34, and I/F unit 34 is connected with an imaging unit 12, an input unit 16, a traveling state detection unit 18, a display 22, and an audio output unit 24. CPU 28, the memories 30, the storage unit 32, and I/F unit 34 are connected to the inner buses 40, respectively, and can communicate with each other.

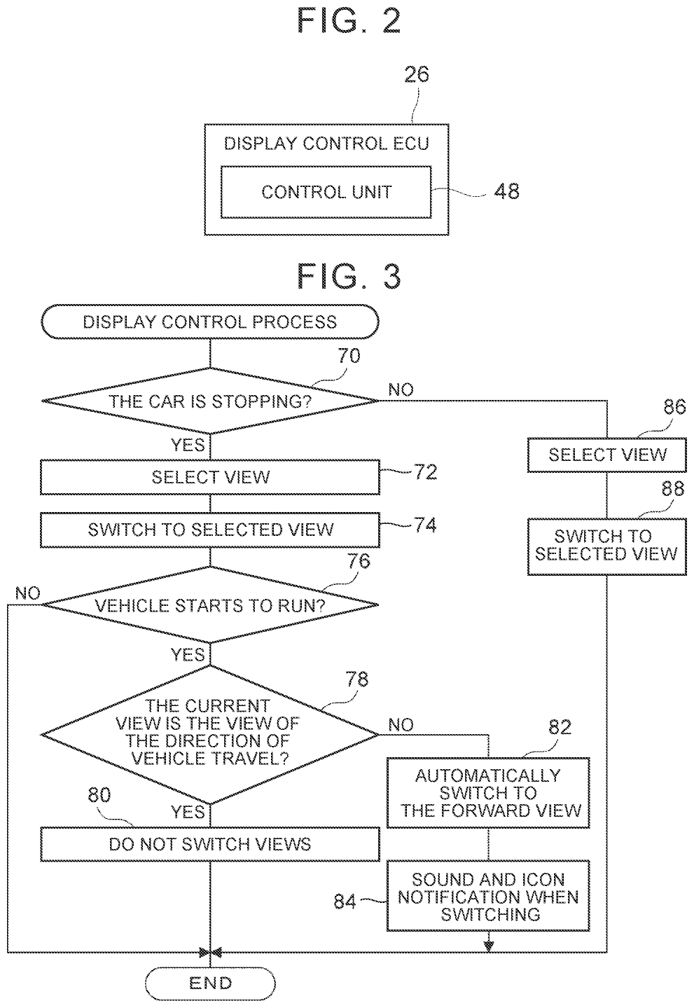

A display control program 42 is stored in the storage unit 32 of the display control ECU 26. The display control ECU 26 functions as the control unit 48 illustrated in FIG. 2 by reading the display control program 42 from the storage unit 32 and expanding it into the memory 30, and executing the display control program 42 expanded in the memory by CPU 28, and performs a display control process (FIG. 3) to be described later. Note that the display control ECU 26 is an exemplary vehicle display control device according to the present disclosure.

The control unit 48 generates a plurality of views (views on the vehicle front side or the vehicle rear side) having different directions from each other based on the captured image acquired from the imaging unit 12 that captures an image of the periphery of the vehicle. In the present embodiment, the control unit 48 adds an auxiliary line 52 for assisting the user to grasp the space to the input image from one camera 14 that captures an image of the front side of the vehicle. As a result, the control unit 48 generates a view on the front side of the vehicle (see FIG. 4A). The control unit 48 adds an auxiliary line 54 for assisting the user in grasping the space to an input image from one camera 14 that captures an image of the rear side of the vehicle. As a result, the control unit 48 generates a view on the rear side of the vehicle (refer to FIG. 4B). Then, the control unit 48 causes the display 22 to display a view in a direction selected from the plurality of generated views via the input unit 16.

Further, when the traveling state detection unit 18 detects that the traveling of the vehicle has started and the view displayed on the display 22 is different from the traveling direction of the vehicle, the control unit 48 switches the view displayed on the display 22 to the view in the traveling direction of the vehicle. The traveling state detection unit 18 detects a traveling state and a traveling direction of the vehicle.

Next, a display control process executed by the control unit 48 while the ignition switch of the vehicle is on will be described with reference to FIG. 3 as an operation of the present embodiment.

In step 70 of the display control process, the control unit 48 determines whether or not the vehicle (host vehicle) is stopping. If the determination in step 70 is affirmative, the process proceeds to step 72. In step 72, when the user selects the direction of the view to be displayed on the display 22 via the input unit 16, the control unit 48 detects this. Then, in step 74, the control unit 48 switches the view displayed on the display 22 to the view in the direction selected by the user via the input unit 16. As described above, while the vehicle is stopped, the user can freely switch the direction of the view to be displayed on the display 22.

In the next step 76, the control unit 48 acquires the traveling state (presence or absence of traveling) and the traveling direction of the vehicle detected by the traveling state detection unit 18 from the traveling state detection unit 18. The control unit 48 determines whether or not the vehicle has started traveling based on the acquired traveling state of the vehicle. When the determination in step 76 is negative, the display control process is ended.

In addition, when the traveling state detection unit 18 detects that the vehicle has started traveling, the determination in step 76 is affirmative, and the process proceeds to step 78. In step 78, the control unit 48 determines whether or not the current view displayed on the display 22 is a view in the traveling direction of the vehicle.

For example, if the detected traveling direction of the vehicle is “backward” while the display 22 is displaying a vehicle rear view (for example, the view shown in 4B), the determination of step 78 is affirmative. Then, the process proceeds to step 80. Also, for example, when the detected traveling direction of the vehicle is “forward” while the front view of the vehicle (for example, the view shown in 4A) is displayed on the display 22, the determination of step 78 is affirmative. Then, the process proceeds to step 80.

In step 80, the control unit 48 does not switch the view. In this way, when the direction of the view displayed on the display 22 is the same as the traveling direction of the vehicle, the view is not switched. Therefore, when the vehicle starts, the user can recognize the state of the traveling direction of the vehicle by the view originally displayed on the display 22.

On the other hand, for example, when the traveling direction of the vehicle is “backward” while the front view of the vehicle (for example, the view shown in 4A) is displayed on the display 22, the determination of step 78 is negative. Then, the process proceeds to step 82. In addition, for example, when a view on the rear side of the vehicle (for example, a view shown in FIG. 4B) is displayed on the display 22 and the traveling direction of the vehicle is “forward”, the determination of step 78 is also negative. Then, the process proceeds to step 82.

In step 82, the control unit 48 automatically switches the view displayed on the display 22 to the view in the traveling direction of the vehicle. For example, when the traveling direction of the vehicle is “backward”, the control unit 48 automatically switches the view displayed on the display 22 from the view on the front side of the vehicle to the view on the rear side of the vehicle. Further, for example, when the traveling direction of the vehicle is “forward”, the control unit 48 automatically switches the view to be displayed on the display 22 from the view on the vehicle rear side to the view on the vehicle front side.

As described above, when the direction of the view displayed on the display 22 is different from the traveling direction of the vehicle, the control unit 48 switches the view displayed on the display 22 to the view in the traveling direction of the vehicle. Accordingly, the user can recognize the state of the traveling direction of the vehicle by the view switched at the time of starting the vehicle.

In the next step 84, the control unit 48 causes the audio output unit 24 to output a predetermined sound (for example, a sound “pi” as an example) and causes the display 22 to display a predetermined icon (for example, an icon indicating switching of a view). As a result, the control unit 48 notifies the user that the view displayed on the display 22 has been switched. This allows the user to recognize that the view displayed on the display 22 has been switched.

Further, in step 70, when the vehicle is traveling, the determination in step 70 is negative. The process then proceeds to step 86. In step 86, when the direction of the view to be displayed on the display 22 is selected by the user via the input unit 16, the control unit 48 detects this. Then, in step 88, the control unit 48 switches the view displayed on the display 22 to the view in the direction selected by the user via the input unit 16.

By the processing of steps 86 and 88, after the vehicle starts traveling and the view displayed on the display 22 is once switched to the view in the traveling direction of the vehicle, the user can freely switch the direction of the view displayed on the display 22.

As described above, in the present embodiment, the control unit 48 displays, on the display 22, a view in a direction selected via the input unit 16 among a plurality of views having different directions obtained from the captured image acquired from the imaging unit 12 that captures an image of the periphery of the vehicle. In addition, when the traveling state detection unit 18 that detects the traveling state and the traveling direction of the vehicle detects that the traveling of the vehicle is started and the view displayed on the display 22 is different from the traveling direction of the vehicle, the control unit 48 switches the view displayed on the display 22 to the view in the traveling direction of the vehicle. Accordingly, it is possible to prevent the user from erroneously recognizing the situation around the vehicle displayed as a view at the time of starting the vehicle as the situation in the traveling direction of the vehicle. The user can recognize the state of the traveling direction of the vehicle from the view displayed on the display 22 when the vehicle starts.

In addition, in the present embodiment, when the control unit 48 switches the view displayed on the display 22 to the view in the traveling direction of the vehicle, the control unit 48 notifies the fact by the audio output unit 24 and the display 22. This allows the user to recognize that the view displayed on the display 22 has been switched.

Further, in the present embodiment, when a view in a direction other than the traveling direction of the vehicle is selected via the input unit 16 after the traveling of the vehicle is started, the control unit 48 switches the view displayed on the display 22 to a view in a direction other than the traveling direction of the vehicle. This allows the user to switch the view displayed on the display 22 to the view selected via the input unit 16 after the travel of the vehicle is started, that is, after the view in the traveling direction of the vehicle is confirmed by the user.

Note that, in the above-described embodiment, a mode has been described in which a view to be displayed on the display 22 is selected from two views, a view on the front side of the vehicle and a view on the rear side of the vehicle. However, the view displayed on the display 22 is not limited to the above. For example, images (3D views) obtained by looking at vehicles and their surroundings from any viewpoint may be generated and displayed from images captured by four or more cameras 14.

In addition, in the above description, an aspect in which the display control program 42, which is an example of the vehicle display control program according to the present disclosure, is stored (installed) in the storage unit 32 in advance has been described. However, the vehicle display control program according to the present disclosure can also be provided in a form recorded in a non-transitory recording medium (storage medium) such as a HDD, SSD, DVD.

Further, the vehicle display control device according to the present disclosure is also applicable to manual driving of a vehicle capable of automatic driving.

What is claimed is:

1. A vehicle display control device comprising a control unit that:
causes a display unit to display a view in a direction selected via an input unit among a plurality of views having different directions obtained from a captured image acquired from an imaging unit that captures an image of a periphery of a vehicle; and
switches the view displayed on the display unit to a view in a traveling direction of the vehicle, when a traveling state detection unit that detects a traveling state and a traveling direction of the vehicle detects that traveling of the vehicle is started and when the view displayed on the display unit is different from the view in the traveling direction of the vehicle.

2. The vehicle display control device according to claim 1, wherein when the control unit switches the view displayed on the display unit to the view in the traveling direction of the vehicle, the control unit causes a notification unit to make a notification.

3. The vehicle display control device according to claim 1, wherein when a view in a direction other than the traveling direction of the vehicle is selected via the input unit after the traveling of the vehicle is started, the control unit switches the view displayed on the display unit to the view in the direction other than the traveling direction.

4. A vehicle display control method comprising causing a computer to execute processes comprising:
causing a display unit to display a view in a direction selected via an input unit among a plurality of views having different directions obtained from a captured image acquired from an imaging unit that captures an image of a periphery of a vehicle; and
switching the view displayed on the display unit to a view in a traveling direction of the vehicle, when a traveling state detection unit that detects a traveling state and a traveling direction of the vehicle detects that traveling of the vehicle is started and when the view displayed on the display unit is different from the view in the traveling direction of the vehicle.

5. A non-transitory storage medium storing a vehicle display control program for causing a computer to execute processes comprising:
causing a display unit to display a view in a direction selected via an input unit among a plurality of views having different directions obtained from a captured image acquired from an imaging unit that captures an image of a periphery of a vehicle; and
switching the view displayed on the display unit to a view in a traveling direction of the vehicle, when a traveling state detection unit that detects a traveling state and a traveling direction of the vehicle detects that traveling of the vehicle is started and when the view displayed on the display unit is different from the view in the traveling direction of the vehicle.
